(19) United States
(12) Patent Application Publication
(10) Pub. No.: US 2026/0122198 A1
(43) Pub. Date: Apr. 30, 2026

(54) ELECTRONIC DEVICE AND DISPLAY CONTROL METHOD THEREOF, AND STORAGE MEDIUM

(71) Applicant: HKC CORPORATION LIMITED, Baoan District (CN)

(72) Inventors: Yun LIN, Shenzhen (CN); Wenqin ZHAO, Shenzhen (CN); Kang LV, Shenzhen (CN); Xiao ZHAO, Shenzhen (CN); Zhihao WANG, Shenzhen (CN); Qianzi LUO, Shenzhen (CN); Tingting YANG, Shenzhen (CN); Lidan YE, Shenzhen (CN)

(21) Appl. No.: 19/361,631

(22) Filed: Oct. 17, 2025

(30) Foreign Application Priority Data
Oct. 30, 2024 (CN) 202411523584.0

(51) Int. Cl. H04N 7/01

(52) U.S. Cl. CPC H04N 7/01

(57) ABSTRACT

A display control method includes: obtaining a video stream which includes multiple frames of input images in sequence of time, the multiple frames of input images having frame numbers in time order; obtaining an index sequence having multiple indexes; determining, for each frame of input image, an index in the index sequence corresponding to the frame of input image according to a frame number of the frame of input image; for each frame of input image, generating a corresponding frame of output image by determining a pixel value of each corresponding pixel in the corresponding frame of output image according to each pixel in the frame of input image and the index corresponding to the frame of input image, to obtain multiple frames of output images; and controlling a display module of an electronic device to output the multiple frames of output images in sequence.

### CROSS-REFERENCE TO RELATED APPLICATIONS

This application claims priority under 35 U.S.C. § 119 (a) to Chinese Patent Application No. 202411523584.0, filed Oct. 30, 2024, the entire disclosure of which is incorporated herein by reference.

### TECHNICAL FIELD

This application relates to the field of display control, and particularly to an electronic device and a display control method thereof, and a storage medium.

### BACKGROUND

The existing electronic paper can only display a binary image in black and white, which means that the electronic paper cannot present other grayscales between black and white, resulting in lacking a sense of depth.

### SUMMARY

In a first aspect, embodiments of the disclosure provide a display control method. The display control method is performed by an electronic device. The electronic device includes a display module. The display control method includes: obtaining a video stream, the video stream including a plurality of frames of input images in sequence of time, the plurality of frames of input images having frame numbers in time order; obtaining an index sequence having a plurality of indexes; determining, for each of the plurality of frames of input images, an index in the index sequence corresponding to the frame of input image according to a frame number of the frame of input image; for each of the plurality of frames of input images, generating a corresponding frame of output image by determining a pixel value of each corresponding pixel in the corresponding frame of output image according to each pixel in the frame of input image and the index corresponding to the frame of input image, to obtain a plurality of frames of output images; and controlling the display module of the electronic device to output the plurality of frames of output images in sequence to display the video stream.

In a second aspect, embodiments of the disclosure provide an electronic device. The electronic device includes a display module, a processor, and a memory. The processor is coupled with the display module and the memory. The memory stores computer programs. The processor is configured to run the computer programs to execute the operations of the display control method described in the first aspect.

In a third aspect, embodiments of the disclosure provide a non-transitory computer-readable storage medium. The non-transitory computer-readable storage medium stores computer programs. The computer programs, when executed by a processor, cause the processor to execute the operations of the display control method described in the first aspect.

### BRIEF DESCRIPTION OF THE DRAWINGS

In order to describe technical solutions of embodiments of the disclosure or the related art more clearly, the following will give a brief description of accompanying drawings used for describing the embodiments or the related art. Apparently, accompanying drawings described below are merely some embodiments. Those of ordinary skill in the art can also obtain other accompanying drawings based on the accompanying drawings described below without creative efforts.

FIG. 1 is a schematic diagram illustrating modules of an electronic device provided in embodiments of the disclosure.

FIG. 2 is a schematic flowchart illustrating a display control method provided in embodiments of the disclosure.

FIG. 3 is a detailed schematic flowchart illustrating an operation S23 of the display control method provided in embodiments of the disclosure.

FIG. 4 is a detailed schematic flowchart illustrating an operation S24 of the display control method provided in embodiments of the disclosure.

FIG. 5 is a detailed schematic flowchart illustrating an operation S242 of the display control method provided in embodiments of the disclosure.

FIG. 6 is a schematic diagram illustrating modules of a processor for controlling a display module provided in embodiments of the disclosure.

Reference signs: 100—electronic device; 10—processor; 20—memory; 30—display module; 21—register; 22—external memory; 11—threshold generation module; 12—image generation module; 13—multiplexer.

### DETAILED DESCRIPTION

In order to describe objects, technical solutions, and advantages of embodiments of the disclosure more clearly, the technical solutions of the embodiments of the disclosure will be described clearly and completely below with reference to accompanying drawings in the embodiments. Apparently, embodiments described below are merely some embodiments, rather than all embodiments of the disclosure. All other embodiments obtained by those of ordinary skill in the art based on the embodiments without creative efforts shall fall within the protection scope of the disclosure.

Unless otherwise defined, all technical and scientific terms used in the disclosure have the same meaning as commonly understood by one of ordinary skill in the technical field to which the disclosure belongs. The terms “one”, “a/an”, “the”, and the like used in the disclosure are not intended to indicate a limitation on quantity, but are merely used to indicate existence of at least one. The terms “include/comprise”, “contain”, and “have” as well as variations thereof are intended to indicate that elements or objects listed before these terms encompass elements or objects listed after these terms as well as their equivalents, without excluding other elements or objects. The terms “connected/coupled”, “linked”, and the like are not limited to physical or mechanical connections, but may also include electrical connections, whether direct or indirect.

The term “embodiment” referred to herein means that particular features, structures, or properties described in conjunction with the embodiments may be defined in at least one embodiment of the disclosure. The phrase “embodiment” appearing in various places in the specification does not necessarily refer to the same embodiment or an independent/alternative embodiment that is mutually exclusive with other embodiments. Those skilled in the art will understand expressly and implicitly that an embodiment described herein may be combined with other embodiments.

In view of the above, the disclosure provides an electronic device and a display control method thereof, and a storage medium, which can solve the above technical problem.

In a first aspect, embodiments of the disclosure provide a display control method. The display control method is performed by an electronic device. The electronic device includes a display module. The display control method includes: obtaining a video stream, the video stream including a plurality of frames of input images in sequence of time, the plurality of frames of input images having frame numbers in time order; obtaining an index sequence having a plurality of indexes; determining, for each of the plurality of frames of input images, an index in the index sequence corresponding to the frame of input image according to a frame number of the frame of input image; for each of the plurality of frames of input images, generating a corresponding frame of output image by determining a pixel value of each corresponding pixel in the corresponding frame of output image according to each pixel in the frame of input image and the index corresponding to the frame of input image, to obtain a plurality of frames of output images; and controlling the display module of the electronic device to output the plurality of frames of output images in sequence to display the video stream.

In a second aspect, embodiments of the disclosure provide an electronic device. The electronic device includes a processor and a memory. The processor is coupled with the display module and the memory. The memory stores computer programs. The processor is configured to run the computer programs to execute the operations of the display control method described in the first aspect.

In a third aspect, embodiments of the disclosure provide a computer-readable storage medium. The computer-readable storage medium stores computer programs. The computer programs are run by a processor to execute the operations of the display control method described in the first aspect.

In the disclosure, a binary or multi-valued device such as electronic paper cannot display a continuous grayscale image. The disclosure aims to convert a continuous grayscale image (input image) into a binary image (output image) to be displayed on the binary or multi-valued device such as electronic paper. Human eyes have a low-pass characteristic and perceptual similarity, where the low-pass characteristic means that the human eyes can perform low-pass filtering on a high-frequency signal, so at a normal viewing distance, the binary image will exhibit an effect of a continuous grayscale image; the perceptual similarity means that the human eyes can integrate similar areas or pixels to form a smoother visual experience, ignoring a specific grayscale of a single pixel, and therefore, the disclosure optimizes a binarization algorithm, that is, the index sequence is introduced; for each of the plurality of frames of input images, the index in the index sequence corresponding to the frame of input image is determined according to the frame number of the frame of input image; for each of the plurality of frames of input images, the corresponding frame of output image is generated by determining the pixel value of each corresponding pixel in the corresponding frame of output image according to each pixel in the frame of input image and the index corresponding to the frame of input image, to obtain the plurality of frames of output images. As can be seen, although the input image is a continuous grayscale image and the output image is a binary or multi-valued non-continuous grayscale image, for each frame of input image, a pixel value of each corresponding pixel in a corresponding frame of output image can be determined according to each pixel in the frame of input image and the index corresponding to the frame of input image, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present, as such, display grayscales of the same pixel in the multiple frames of input images and corresponding frames of output images are closer. As such, an image viewer will not obviously perceive limitation due to using only two grayscales, so that an image displayed on a binary device such as electronic paper or a multi-valued device has an effect of display of a continuous grayscale image, and is closer to a continuous grayscale image, and therefore, a display performance of the binary device such as electronic paper or the multi-valued device can be improved effectively, allowing the viewer to visually feel a sense of depth (or hierarchy) and continuity, thereby achieving a better visual experience, and enhancing practicality and aesthetic appeal of such device in actual applications.

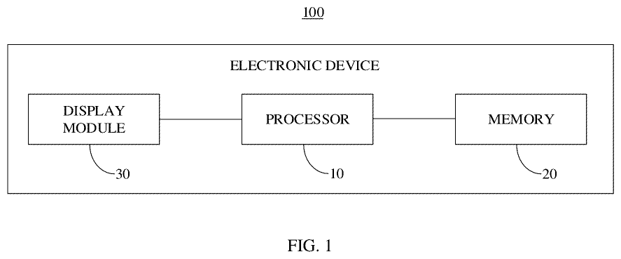

Referring to FIG. 1, FIG. 1 is a schematic diagram illustrating modules of an electronic device 100 provided in embodiments of the disclosure. The electronic device 100 may be, but is not limited to, a multi-valued device or a binary device such as an e-book, a monochrome display device, or an electronic device equipped with a binary device or a multi-valued device such as a mobile phone and a tablet. The binary device may be a device that can only display a binary image in black and white but cannot display a continuous grayscale image, including but not limited to electronic paper, a monochrome display device, a digital camera operating in a black-and-white mode, etc. The multi-valued device may be, but is not limited to, a device that can display an image of other grayscales in addition to black and white but cannot display a continuous grayscale image. In these embodiments, the electronic device 100 is electronic paper. The electronic device 100 includes a processor 10, a memory 20, and a display module 30. The processor 10 is coupled with the memory 20 and the display module 30.

The processor 10 may be, but is not limited to, a Central Processing Unit (CPU), other general-purpose processors, a Digital Signal Processor (DSP), an Application Specific Integrated Circuit (ASIC), a Field-Programmable Gate Array (FPGA) or other programmable logic devices, a discrete gate or a transistor logic device, a discrete hardware component, etc.

The memory 20 may include a high-speed Random Access Memory (RAM), and may also include a non-transitory memory, such as a hard disk, a memory, a plug-in hard disk, a Smart Media Card (SMC), a Secure Digital (SD) card, a flash card, multiple disk storage devices, a flash memory device, or other transitory solid-state storage devices.

The display module 30 is a display assembly for displaying a binary image or a multi-valued image, such as a display module of electronic paper.

In some embodiments, the memory 20 stores computer programs. The processor 10 is configured to run the computer programs to execute the operations of the display control method.

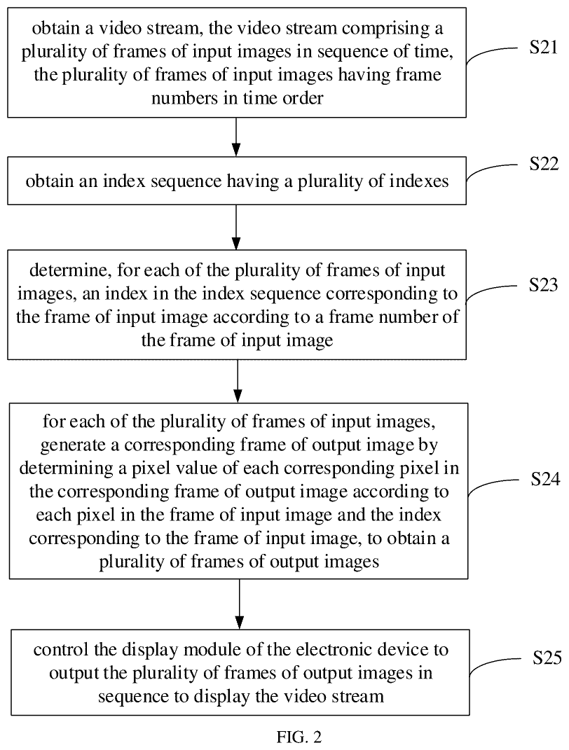

Referring to FIG. 2, FIG. 2 is a schematic flowchart illustrating a display control method provided in embodiments of the disclosure. The display control method includes the following.

S21, obtain a video stream, the video stream includes multiple frames of input images in sequence of time, the multiple frames of input images have frame numbers in time order.

S22, obtain an index sequence having multiple indexes.

S23, for each of the multiple frames of input images, determine an index in the index sequence corresponding to the frame of input image according to a frame number of the frame of input image.

S24, for each of the multiple frames of input images, generate a corresponding frame of output image by determining a pixel value of each corresponding pixel (point) in the corresponding frame of output image according to each pixel (point) in the frame of input image and the index corresponding to the frame of input image, to obtain multiple frames of output images.

S25, control a display module 30 of an electronic device 100 to output the multiple frames of output images in sequence to display the video stream.

It is to be noted that, in the disclosure, the term “multiple frames of input images” can be referred to as “multiple input pictures”, and the term “multiple frames of output images” can be referred to as “multiple output pictures”. In addition, the term “frame number” can be referred to as a frame sequence number, and refers to a unique identifier assigned to a frame of image/picture in a video stream, that is, the “frame number” can be used to distinguish different images/pictures in the video stream. The frame numbers are arranged in the order in which the images appear in the video stream, thereby establishing temporal or spatial relationship between frames.

In the disclosure, a binary or multi-valued device such as electronic paper cannot display a continuous grayscale image. The disclosure aims to convert a continuous grayscale image (input image) into a binary image (output image) to be displayed on the binary or multi-valued device such as electronic paper. Human eyes have a low-pass characteristic and perceptual similarity, where the low-pass characteristic means that the human eyes can perform low-pass filtering on a high-frequency signal, so at a normal viewing distance, the binary image will exhibit an effect of a continuous grayscale image; the perceptual similarity means that the human eyes can integrate similar areas or pixels to form a smoother visual experience, ignoring a specific grayscale of a single pixel, and therefore, a binarization algorithm is optimized in the disclosure, that is, the index sequence is introduced; for each of the multiple frames of input images, the index in the index sequence corresponding to the frame of input image is determined according to the frame number of the frame of input image; for each of the multiple frames of input images, the corresponding frame of output image is generated by determining the pixel value of each corresponding pixel in the corresponding frame of output image according to each pixel in the frame of input image and the index corresponding to the frame of input image, to obtain the multiple frames of output images. As can be seen, although the input image is a continuous grayscale image and the output image is a binary or multi-valued non-continuous grayscale image, for each frame of input image, a pixel value of each corresponding pixel in a corresponding frame of output image can be determined according to each pixel in the frame of input image and the index corresponding to the frame of input image, which can optimize distribution of pixel values of the same pixel (or same pixel position) in multiple frames of output images, so that after visual color mixing, the pixel values of the same pixel in the multiple frames of output images can present a display grayscale other than a grayscale that the pixel values of the pixel per se can present, as such, display grayscales of the same pixel in the multiple frames of input images and corresponding frames of output images are closer. As such, an image viewer will not obviously perceive limitation due to using only two grayscales, so that an image displayed on a binary device such as electronic paper or a multi-valued device has an effect of display of a continuous grayscale image, and is closer to a continuous grayscale image, and therefore, a display performance of the binary device such as electronic paper or the multi-valued device can be improved effectively, allowing the viewer to visually feel a sense of depth (or hierarchy) and continuity, thereby achieving a better visual experience, and enhancing practicality and aesthetics in actual applications.

In some embodiments, the number of indexes in the index sequence is greater than or equal to 2.

In some embodiments, the number of elements in the index sequence may be 4, 8, 16, 32, 64, 128, etc., which is not limited herein.

In some embodiments, at least part of the indexes in the index sequence are different. In these embodiments, values of all elements in the index sequence are different from one another.

In some embodiments, a maximum value among all indexes in the index sequence is less than or equal to N-1, and a minimum value among all indexes in the index sequence is greater than or equal to zero. In other embodiments, the maximum value and the minimum value among all indexes in the index sequence can be determined according to an actual situation, which are not limited herein.

In some embodiments, the input image is a continuous grayscale image, while the output image is a binary image.

In other embodiments, the input image is a high-grayscale image, while the output image is a low-grayscale image, where the high-grayscale image and the low-grayscale image are relative concepts, and the number of displayed grayscales of the high-grayscale image is greater than the number of displayed grayscales of the low-grayscale image.

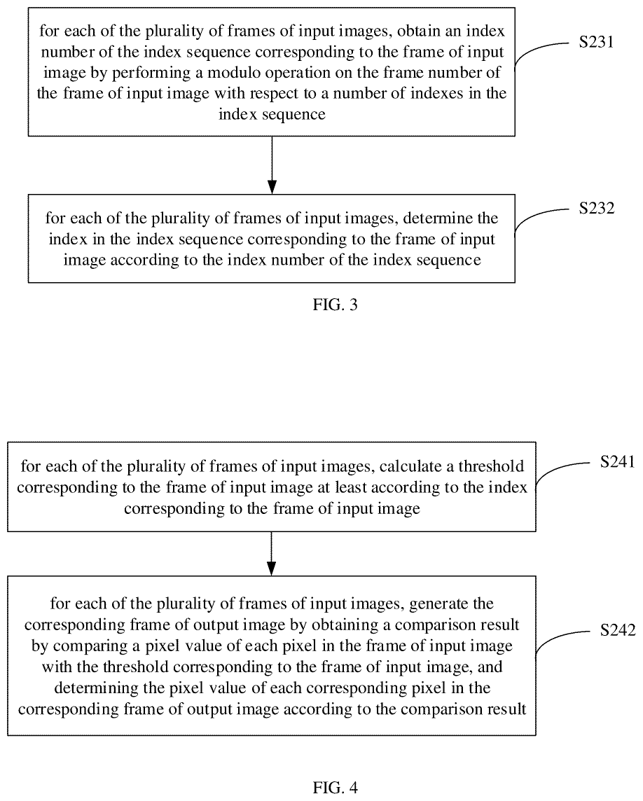

In some embodiments, referring to FIG. 3, FIG. 3 is a detailed schematic flowchart illustrating the operation S23 of the display control method provided in embodiments of the disclosure. It is understandable that, the operations in FIG. 3 may be reordered or increased or decreased according to actual needs, which is not limited herein. The operation S23 includes the following.

S231, for each of the multiple frames of input images, obtain an index number of the index sequence corresponding to the frame of input image by performing a modulo operation on the frame number of the frame of input image with respect to a number of indexes in the index sequence.

S232, for each of the multiple frames of input images, determine the index in the index sequence corresponding to the frame of input image according to the index number of the index sequence.

In the disclosure, the term “index number” refers to a unique identifier assigned to an index in the index sequence, and typically represents a position or order of an index in the index sequence itself.

In some embodiments, a formula corresponding to the operation S23 is I(imodN), where i represents the frame number of the frame of input image, N represents the number of indexes in the index sequence, and imodN represents a result of i modulo N.

In other embodiments, a formula corresponding to the operation S231 is a remainder operation, which is not limited herein.

In the disclosure, when the number of indexes in the index sequence is less than the number of frames of input images or output images, an index corresponding to each frame of input image can be determined according to the modulo operation, so that the index sequence can be miniaturized, thereby saving a system memory.

In some embodiments, the output image is a binary image, and each pixel of the output image may take a value of 0 or 255. When the number of indexes in the index sequence is 4, multiple frames of output images are divided into multiple output-image groups in sequence of time, and each of the output-image groups also includes 4 frames of output images, in which the number of output images is the same as the number of indexes in the index sequence, output images in each of the output-image groups are in one-to-one correspondence with indexes in the index sequence, and thus, for each frame of output image in the output-image group, a pixel value of each pixel in the frame of output image is calculated according to a pixel value of each pixel in a corresponding frame of input image and an index corresponding to the corresponding frame of input image. Therefore, for each frame of output image in each of the output-image groups, a pixel value of each pixel in the frame of output image can be adjusted according to a corresponding index in the index sequence, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present. When the number of indexes in the index sequence is 4, if pixel values of the same pixel of the output-image group each are 0, a display grayscale that can be visually presented is the average of the sum of the pixel values of the same pixel of the output-image group, that is, 0. Similarly, if only one pixel value among pixel values of the same pixel of the output-image group is 255 and the other pixel values each are 0, a display grayscale that can be visually presented is the average of the sum of the pixel values of the same pixel of the output-image group, that is, 255/4=64. Similarly, if only two pixel values among pixel values of the same pixel of the output-image group each are 255 and the other two pixel values each are 0, a display grayscale that can be visually presented is the average of the sum of the pixel values of the same pixel of the output-image group, that is, 510/4=128. Similarly, the same pixel of the output-image group can also have a display grayscale of 192 or 255. For another example, when the number of indexes in the index sequence is 16, multiple frames of output images are divided into multiple output-image groups in sequence of time, and each of the output-image groups also includes 16 frames of output images, in which the number of output images is the same as the number of indexes in the index sequence, output images in each of the output-image groups are in one-to-one correspondence with indexes in the index sequence, and thus, for each frame of output image in the output-image group, a pixel value of each pixel in the frame of output image is calculated according to a pixel value of each pixel in a corresponding frame of input image and an index corresponding to the corresponding frame of input image. Therefore, for each frame of output image in each of the output-image groups, a pixel value of each pixel in the frame of output image can be adjusted according to a corresponding index in the index sequence, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present. When the number of indexes in the index sequence is 16, the same pixel of the output-image group can visually present 17 kinds of display grayscales, that is, 0, 16, 32, 48, 64, 80, 96, 112, 128, 144, 160, 176, 192, 208, 224, 240, 255. For still another example, when the number of indexes in the index sequence is 64, multiple frames of output images are divided into multiple output-image groups in sequence of time, and each of the output-image groups also includes 64 frames of output images, in which the number of output images is the same as the number of indexes in the index sequence, output images in each of the output-image groups are in one-to-one correspondence with indexes in the index sequence, and thus, for each frame of output image in the output-image group, a pixel value of each pixel in the frame of output image is calculated according to a pixel value of each pixel in a corresponding frame of input image and an index corresponding to the corresponding frame of input image. Therefore, for each frame of output image in each of the output-image groups, a pixel value of each pixel in the frame of output image can be adjusted according to a corresponding index in the index sequence, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present. When the number of indexes in the index sequence is 64, the same pixel of the output-image group can visually present 65 kinds of display grayscales, that is, 0, 4, 8, 12, 16, 20, 24, 28, 32, 36, 40, 44, 48, 52, 56, 60, 64, 68, 72, 76, 80, 84, 88, 92, 96, 100, 104, 108, 112, 116, 120, 124, 128, 1 32, 136, 140, 144, 148, 152, 156, 160, 164, 168, 172, 176, 180, 184, 188, 192, 196, 200, 204, 208, 212, 216, 220, 224, 228, 232, 236, 240, 244, 248, 252, 255.

In the disclosure, the larger the number of indexes in the index sequence, the more display grayscales presented by the same pixel in the multiple frames of output images after visual color mixing. The number of indexes in the index sequence is proportional to the number of display grayscales presented by the same pixel in the multiple frames of output images after visual color mixing. In view of the above, the number of indexes in the index sequence can be adjusted according to needs, and accordingly, the number of display grayscales presented by the same pixel in the multiple frames of output images after visual color mixing is adjusted, thereby improving the layered effect of display of the multiple frames of output images.

In some embodiments, referring to FIG. 4, FIG. 4 is a detailed schematic flowchart illustrating the operation S24 of the display control method provided in embodiments of the disclosure. It is understandable that, the operations in FIG. 4 may be reordered or increased or decreased according to actual needs, which is not limited herein. The operation S24 includes the following.

S241, for each of the multiple frames of input images, calculate a threshold corresponding to the frame of input image at least according to the index corresponding to the frame of input image.

S242, for each of the multiple frames of input images, obtain a comparison result by comparing a pixel value of each pixel in the frame of input image with the threshold corresponding to the frame of input image, and determine the pixel value of each corresponding pixel in the corresponding frame of output image according to the comparison result, to generate the corresponding frame of output image.

Firstly, for each frame of input image, the threshold corresponding to the frame of input image is calculated at least according to the index corresponding to the frame of input image. As such, each frame of input image has a corresponding threshold, and the magnitude of the threshold is related to the magnitude of the determined index corresponding to each frame of input image. Further, for each frame of input image, the comparison result is obtained by comparing the pixel value of each pixel in the frame of input image with the threshold corresponding to the frame of input image, and the pixel value of each corresponding pixel in the corresponding frame of output image is determined according to the comparison result, to generate the corresponding frame of output image. As such, for each frame of input image, the pixel value of each corresponding pixel in the corresponding frame of output image is determined according to each pixel in the frame of input image and an index corresponding to the frame of input image, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present. As such, an image viewer will not obviously perceive limitation due to using only two grayscales, so that an image displayed on a binary device such as electronic paper or a multi-valued device has an effect of display of a continuous grayscale image, and is closer to a continuous grayscale image, and therefore, a display performance of the binary device such as electronic paper or the multi-valued device can be improved effectively, allowing the viewer to visually feel a sense of depth and continuity, thereby achieving a better visual experience, and enhancing practicality and aesthetics in actual applications.

In some embodiments, the operation S241 specifically includes: for each of the multiple frames of input images, obtaining the threshold corresponding to the frame of input image according to the index corresponding to the frame of input image and a number of indexes in the index sequence.

In the disclosure, for each frame of input image, the threshold corresponding to the frame of input image can be obtained according to the index corresponding to the frame of input image and the number of indexes in the index sequence. A calculation process is simple, and the amount of calculation is small, thereby improving a calculation speed.

In some embodiments, obtaining, for each of the multiple frames of input images, the threshold corresponding to the frame of input image according to the index corresponding to the frame of input image and the number of the indexes in the index sequence specifically includes: for each of the multiple frames of input images, obtaining the threshold corresponding to the frame of input image according to a first calculation formula, the index corresponding to the frame of input image, and the number of the indexes in the index sequence, where the first calculation formula is:

$$T ( i ) = 255 \times \frac{I ( i mod N ) + 0.5}{N} ;$$

where i represents the frame number of the frame of input image, N represents the number of the indexes in the index sequence, I(imodN) represents an index (in the index sequence) corresponding to an i^{th} frame of input image, imodN represents a result of i modulo N, and T(i) represents a threshold for the i^{th} frame of input image.

According to the above calculation formula, the threshold for each frame of input image can be calculated with a simple calculation process. An index sequence having a small number of indexes is used. By performing a modulo operation on the frame number of a frame of input image with respect to the number of the indexes, the frame of input image can correspond to a specific index in the index sequence; further, the threshold for the frame of input image is calculated according to a ratio of the index to the number of the indexes in the index sequence, which can reduce the number of the indexes in the index sequence and a space occupied by the index sequence.

It is understandable that, in other embodiments, for each frame of input image, the pixel value of each pixel in the corresponding frame of output image can be directly calculated according to the pixel value of each pixel in the frame of input image and the index corresponding to the frame of input image, which is not limited herein.

It is understandable that, in other embodiments, the first calculation formula can be adjusted according to actual needs, for example, adjusting the value of the constant “0.5”, etc., which is not limited herein.

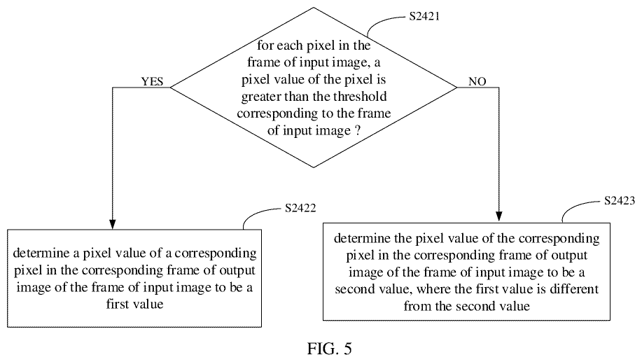

In some embodiments, referring to FIG. 5, FIG. 5 is a detailed schematic flowchart illustrating the operation S242 of the display control method provided in embodiments of the disclosure. It is understandable that, the operations in FIG. 5 may be reordered or increased or decreased according to actual needs, which is not limited herein. The operation S242 specifically includes the following.

S2421, for each pixel in the frame of input image, determine whether a pixel value of the pixel is greater than the threshold corresponding to the frame of input image. If yes, proceed to an operation S2422; otherwise, proceed to an operation S2423.

S2422, determine a pixel value of a corresponding pixel in the corresponding frame of output image of the frame of input image to be a first value.

S2423, determine the pixel value of the corresponding pixel in the corresponding frame of output image of the frame of input image to be a second value, where the first value is different from the second value.

In some embodiments, a calculation formula for the operation S242 is:

$$if c ( i , x , y ) > T ( i ) , h ( i , x , y ) = 255 ; otherwise , h ( i , x , y ) = 0 ;$$

where h(i,x,y)=represents a pixel value of a pixel at an x^{th} row and a y^{th} column in an i^{th} frame of output image, c(i,x,y) represents a pixel value of a pixel at an x^{th} row and a y^{th} column in an i^{th} frame of input image, T(i) represents a threshold for the i^{th} frame of input image, i represents the frame number, x represents a row value/number of a pixel in the frame of input/output image, and y represents a column value/number of the pixel in the frame of input/output image.

In these embodiments, the first value is 255, and the second value is 0. In other embodiments, the first value is 0, and the second value is 255. In yet other embodiments, the first value and the second value can take on other values. The disclosure is not limited thereto.

In the disclosure, a continuous grayscale image (input image) can be converted into a binary image (output image) to be displayed on a binary or multi-valued device such as electronic paper. Moreover, by comparing a pixel value of a pixel in the frame of input image with a threshold corresponding to the frame of input image, an operation process involved in converting the continuous grayscale image (input image) into the binary image (output image) can be simplified, thereby improving an image conversion efficiency.

In some embodiments, the operation S24 can be implemented through two algorithms, and the two algorithms specifically include a time disordered dithering algorithm and a time ordered dithering algorithm. The time disordered dithering algorithm refers to that index values of all elements in the index sequence are assigned randomly and have no regularity. The time ordered dithering algorithm refers to that index values of all elements in the index sequence are not assigned randomly and have a certain regularity.

The formulas for the operation S241 corresponding to the two algorithms are the same, and the formulas for the operation S242 corresponding to the two algorithms are the same. Specifically, a first calculation formula for the operation S241 is:

$$T ( i ) = 255 \times \frac{I ( i mod N ) + 0.5}{N} ;$$

where i represents the frame number of the frame of input image, N represents the number of indexes in the index sequence, I(imodN) represents an index (in the index sequence) corresponding to an i^{th} frame of input image, imodN represents a result of i modulo N, and T(i) represents a threshold for the i^{th} frame of input image.

Specifically, a calculation formula for the operation S242 is:

$$if c ( i , x , y ) > T ( i ) , h ( i , x , y ) = 255 ; otherwise , h ( i , x , y ) = 0 ;$$

where h(i,x,y) represents a pixel value of a pixel at an x^{th} row and a y^{th} column in an i^{th} frame of output image, c(i,x,y) represents a pixel value of a pixel at an x^{th} row and a y^{th} column in an i^{th} frame of input image, T(i) represents a threshold for the i^{th} frame of input image, i represents the frame number, x represents a row value/number of a pixel in the frame of input/output image, and y represents a column value/number of the pixel in the frame of input/output image.

The difference between the above two algorithms lies in that index sequences used by the above two algorithms are different.

In a first embodiment, the index sequence used by the time disordered dithering algorithm is a random sequence, and an example of the index sequence is: I=[0,2,3,1]. In other embodiments, the index sequence may also be exemplified as: I=[0,1,3,2].

In other embodiments, the number of indexes in the index sequence may also be 16, 64, etc.

Therefore, for the time disordered dithering algorithm, the index sequence is a random sequence, and values of all elements in the index sequence are different from one another. It can be understood that, the index sequence may have 4 elements, 8 elements, 16 elements, 32 elements, 64 elements, 128 elements, etc., which is not limited herein.

In the following, the algorithm will be explained using an example where a pixel value of a pixel at row 0 and column 0 in a 0th frame of input image is 64, a pixel value of a pixel at row 0 and column 0 in a 1st frame of input image is 64, a pixel value of a pixel at row 0 and column 0 in a 2nd frame of input image is 64, and a pixel value of a pixel at row 0 and column 0 in a 3rd frame of input image is 64, as detailed below:

$$c ( 0 , 0 , 0 ) = 64 , c ( 1 , 0 , 0 ) = 64 , c ( 2 , 0 , 0 ) = 64 , c ( 3 , 0 , 0 ) = 64 .$$

If the index sequence is I=[0,2,3,1], the number of indexes in the index sequence I is N=4.

When calculating a threshold T(0) corresponding to the 0th frame of input image, since i=0, a 0th index of 0 in the index sequence I needs to be selected according to imodN=0, in this case,

$$T ( 0 ) = 255 \times \frac{0 + 0.5}{4} = 31.875 .$$

A pixel value of each pixel h(0,x,y) in a 0th frame of output image satisfies:

$$if c ( 0 , x , y ) > T ( 0 ) , h ( 0 , x , y ) = 255 ; otherwise , h ( 0 , x , y ) = 0$$

in view of the above, a pixel value of h(0,0,0) is determined to be 255.

When calculating a threshold T(1) corresponding to the 1st frame of input image, since i=1, a 1st index of 2 in the index sequence I needs to be selected according to imodN=1, in this case,

$$T ( 1 ) = 255 \times \frac{2 + 0. 5}{4} = 159.375 .$$

A pixel value of each pixel h(1,x,y) in a 1st frame of output image satisfies:

$$if c ( 1 , x , y ) > T ( 1 ) , h ( 1 , x , y ) = 255 ; otherwise , h ( 1 , x , y ) = 0 ;$$

in view of the above, a pixel value of h(1,0,0) is determined to be 0.

When calculating a threshold T(2) corresponding to the 2nd frame of input image, since i=2, a 2nd index of 3 in the index sequence I needs to be selected according to imodN=2, in this case,

$$T ( 2 ) = 255 \times \frac{3 + 0.5}{4} = 223.125 .$$

A pixel value of each pixel h(2,x,y) in a 2nd frame of output image satisfies:

$$if c ( 2 , x , y ) > T ( 2 ) , h ( 2 , x , y ) = 255 ; otherwise , h ( 2 , x , y ) = 0 ;$$

in view of the above, a pixel value of h(2,0,0) is determined to be 0.

When calculating a threshold T(3) corresponding to the 3rd frame of input image, since i=3, a 3rd index of 1 in the index sequence I needs to be selected according to imodN=3, in this case,

$$T ( 3 ) = 255 * \frac{1 + 0.5}{4} = 95.625 .$$

A pixel value of each pixel h(3,x,y) in a 3rd frame of output image satisfies:

$$if c ( 3 , x , y ) > T ( 3 ) , h ( 3 , x , y ) = 255 ; otherwise , h ( 3 , x , y ) = 0 ;$$

in view of the above, a pixel value of h(3,0,0) is determined to be 0.

As can be seen, the pixel value of the pixel at row 0 and column 0 in the 0th frame of input image is 64, the pixel value of the pixel at row 0 and column 0 in the 1st frame of input image is 64, the pixel value of the pixel at row 0 and column 0 in the 2nd frame of input image is 64, and the pixel value of the pixel at row 0 and column 0 in the 3rd frame of input image is 64, and accordingly, the pixel value of the pixel at row 0 and column 0 in the 0th frame of output image is 255, the pixel value of the pixel at row 0 and column 0 in the 1st frame of output image is 0, the pixel value of the pixel at row 0 and column 0 in the 2nd frame of output image is 0, and the pixel value of the pixel at row 0 and column 0 in the 3rd frame of output image is 0. Since human eyes have a low-pass characteristic, a binary image will present a visual effect of a continuous grayscale image when the binary image is observed at a normal observation distance, in this case, a value of a display grayscale of pixels h(0,0,0), h(1,0,0), h(2,0,0), and h(3,0,0) in sequence of time, which is perceived by the human eyes, is an average value (i.e., 64) of pixels h(0,0,0), h(1,0,0), h(2,0,0), and h(3,0,0), that is, a grayscale value other than 0 and 255. As such, although the output image is a binary image, the output image has a display effect of presenting more grayscales, making the output image more layered.

Thus, in the first embodiment, for each frame of input image, the threshold corresponding to the frame of input image is calculated at least according to the index corresponding to the frame of input image; for each frame of input image, the comparison result is obtained by comparing the pixel value of each pixel in the frame of input image with the threshold corresponding to the frame of input image, and the pixel value of each corresponding pixel in the corresponding frame of output image is determined according to the comparison result, to generate the corresponding frame of output image. Since the index sequence is a random sequence, the pixel value of each pixel in the output image has low dependence on the selected index sequence. Therefore, only one index sequence needs to be pre-stored, thus occupying a relatively small amount of memory.

In a second embodiment, the index sequence used by the time ordered dithering algorithm is an ordered sequence, and an example of the index sequence is as follows: I=[0,1,2,3].

In other embodiments, the index sequence may also be exemplified as: I=[1,3,5,7].

It can be understood that, for the time ordered dithering algorithm, the index sequence is an ordered sequence, and values of all elements in the ordered sequence are different from one another. It can be understood that, the index sequence may have 4 elements, 8 elements, 16 elements, 32 elements, 64 elements, 128 elements, or the like, which is not limited herein.

In the second embodiment, as for the specific implementation for calculating, for each frame of input image, the threshold corresponding to the frame of input image at least according to the index corresponding to the frame of input image, and as for the specific implementation for generating, for each frame of input image, the corresponding frame of output image by obtaining the comparison result by comparing the pixel value of each pixel in the frame of input image with the threshold corresponding to the frame of input image and determining the pixel value of each corresponding pixel in the corresponding frame of output image according to the comparison result, these specific implementations in the second embodiment are the same as specific implementations in the first embodiment, which will not be repeated herein.

In the second embodiment, by controlling a difference between adjacent values in the index sequence, a brightness variation between different frames can be controlled, thereby reducing flicker.

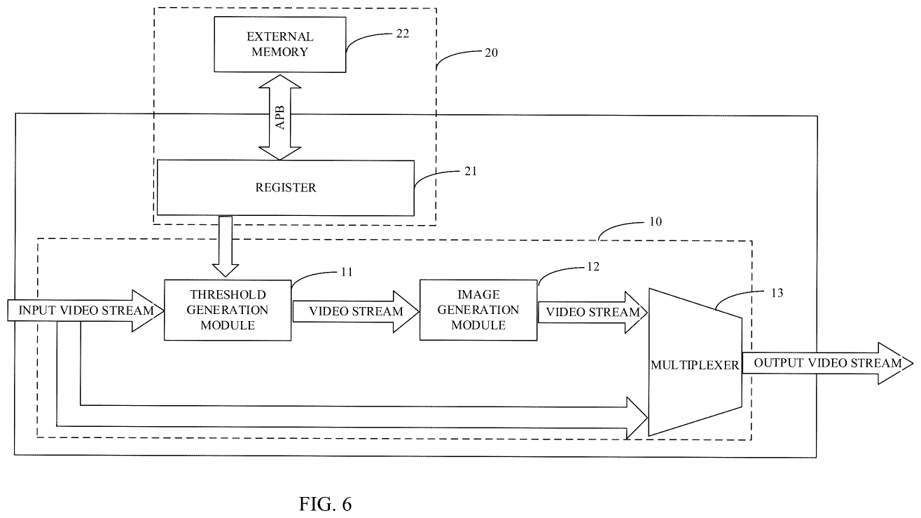

Referring to FIG. 6, FIG. 6 is a schematic diagram illustrating modules of a processor 10 for controlling a display module 30 provided in embodiments of the disclosure. Specifically, the memory 20 includes a register 21 and an external memory 22. The processor 10 is coupled with the register 21. The register 21 interacts with the external memory 22 via an Advanced Peripheral Bus (APB), and the index sequence is read from the external memory 22 to the register 21 for temporary storage. It can be understood that, the processor 10 is configured to: obtain a video stream, the video stream including multiple frames of input images in sequence of time, the multiple frames of input images having frame numbers in time order; obtain an index sequence having multiple indexes; determine, for each of the multiple frames of input images, an index in the index sequence corresponding to the frame of input image according to a frame number of the frame of input image; for each of the multiple frames of input images, generate a corresponding frame of output image by determining a pixel value of each corresponding pixel in the corresponding frame of output image according to each pixel in the frame of input image and the index corresponding to the frame of input image, to obtain multiple frames of output images; and control the display module 30 of the electronic device 100 to output the multiple frames of output images in sequence to display the video stream.

In the disclosure, a binarization algorithm is optimized, that is, the index sequence is introduced; for each of the multiple frames of input images, the index in the index sequence corresponding to the frame of input image is determined according to the frame number of the frame of input image; for each of the multiple frames of input images, the corresponding frame of output image is generated by determining the pixel value of each corresponding pixel in the corresponding frame of output image according to each pixel in the frame of input image and the index corresponding to the frame of input image, to obtain the multiple frames of output images. As can be seen, although the input image is a continuous grayscale image and the output image is a binary or multi-valued non-continuous grayscale image, for each frame of input image, a pixel value of each corresponding pixel in a corresponding frame of output image can be determined according to each pixel in the frame of input image and the index corresponding to the frame of input image, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present, as such, display grayscales of the same pixel in the multiple frames of input images and corresponding frames of output images are closer. As such, an image viewer will not obviously perceive limitation due to using only two grayscales, so that an image displayed on a binary device such as electronic paper or a multi-valued device has an effect of display of a continuous grayscale image, and is closer to a continuous grayscale image, and therefore, a display performance of the binary device such as electronic paper or the multi-valued device can be improved effectively, allowing the viewer to visually feel a sense of depth and continuity, thereby achieving a better visual experience, and enhancing practicality and aesthetics in actual applications.

Specifically, the processor 10 includes a threshold generation module 11 and an image generation module 12. The threshold generation module 11 is coupled with the register 21. The threshold generation module 11 has two input sources, one of the two input sources is multiple frames of input images (multiple frames of input images in an input video stream), and the other is an index sequence from the register 21. The threshold generation module 11 is configured to: determine, for each of the multiple frames of input images, an index in the index sequence corresponding to the frame of input image according to a frame number of the frame of input image, and calculate, for each of the multiple frames of input images, a threshold corresponding to the frame of input image at least according to the index corresponding to the frame of input image. The image generation module 12 is configured to generate, for each of the multiple frames of input images, the corresponding frame of output image (multiple frames of output images in an output video stream) by: obtaining a comparison result by comparing a pixel value of each pixel in the frame of input image with the threshold corresponding to the frame of input image, and determining the pixel value of each corresponding pixel in the corresponding frame of output image according to the comparison result.

Firstly, for each frame of input image, the threshold corresponding to the frame of input image is calculated at least according to the index corresponding to the frame of input image. As such, each frame of input image has a corresponding threshold, and the magnitude of the threshold is related to the magnitude of the determined index corresponding to each frame of input image. Further, for each frame of input image, the comparison result is obtained by comparing the pixel value of each pixel in the frame of input image with the threshold corresponding to the frame of input image, and the pixel value of each corresponding pixel in the corresponding frame of output image is determined according to the comparison result, to generate the corresponding frame of output image. As such, for each frame of input image, the pixel value of each corresponding pixel in the corresponding frame of output image is determined according to each pixel in the frame of input image and the index corresponding to the frame of input image, which can optimize distribution of pixel values of the same pixel in multiple frames of output images, so that after visual color mixing, the pixel values of the same pixel in the multiple frames of output images can present a display grayscale other than a grayscale that the pixel values of the pixel per se can present. As such, an image viewer will not obviously perceive limitation due to using only two grayscales, so that an image displayed on a binary device such as electronic paper or a multi-valued device has an effect of display of a continuous grayscale image, and is closer to a continuous grayscale image, and therefore, a display performance of the binary device such as electronic paper or the multi-valued device can be improved effectively, allowing the viewer to visually feel a sense of depth and continuity, thereby achieving a better visual experience, and enhancing practicality and aesthetics in actual applications.

In some embodiments, the threshold generation module 11 is configured to obtain, for each of the multiple frames of input images, the threshold corresponding to the frame of input image according to the index corresponding to the frame of input image and a number of indexes in the index sequence.

In the disclosure, for each frame of input image, the threshold corresponding to the frame of input image can be obtained according to the index corresponding to the frame of input image and the number of indexes in the index sequence. A calculation process is simple, and the amount of calculation is small, thereby improving a calculation speed.

In some embodiments, the image generation module 12 is configured to: determine, for each pixel in the frame of input image, whether a pixel value of the pixel is greater than the threshold corresponding to the frame of input image; if yes, determine a pixel value of a corresponding pixel in the corresponding frame of output image of the frame of input image to be a first value; otherwise, determine the pixel value of the corresponding pixel in the corresponding frame of output image of the frame of input image to be a second value, where the first value is different from the second value.

In the disclosure, a continuous grayscale image (input image) can be converted into a binary image (output image) to be displayed on a binary or multi-valued device such as electronic paper. Moreover, by comparing a pixel value of a pixel in the frame of input image with a threshold corresponding to the frame of input image, an operation process involved in converting the continuous grayscale image (input image) into the binary image (output image) can be simplified, thereby improving an image conversion efficiency.

In some embodiments, both the threshold generation module 11 and the image generation module 12 can use the above two algorithms, which will not be repeated herein.

In some embodiments, the processor 10 further includes a multiplexer 13. The multiplexer 13 is coupled with an output end of the image generation module 12 and an input end of the threshold generation module 11. When the multiplexer 13 chooses to enable a dithering algorithm, an output video stream is generated and outputted through the multiplexer 13 after a video stream flows from the threshold generation module 11 to the image generation module 12. When the multiplexer 13 chooses not to enable the dithering algorithm, the video stream is directly outputted through the multiplexer 13 without passing through the threshold generation module 11 and the image generation module 12.

The multiplexer 13 can be used to choose to perform processing on the video stream through the dithering algorithm or used to choose not to perform processing on the video stream through the dithering algorithm, thereby increasing diversity of the output video stream.

In the foregoing embodiments, the description of each embodiment has its own emphasis. For the parts not described in detail in one embodiment, reference may be made to related descriptions in other embodiments.

It will be understood by those of ordinary skill in the art that all or part of the various methods of the embodiments described above may be accomplished by means of a program to instruct associated hardware, the program may be stored in a computer-readable memory. The memory may include a flash memory, a Read-Only Memory (ROM), an RAM, disk or Compact Disc (CD), etc.

Embodiments of the disclosure further provide a computer-readable storage medium. The computer-readable storage medium stores computer programs which are run by a processor to execute the operations of the above display control method.

In sum, the foregoing embodiments are merely used for illustrating the technical solutions of the disclosure rather than limiting the disclosure. While the disclosure has been described in detail in connection with the foregoing embodiments, it should be understood by those of ordinary skill in the art that modifications may still be made to the technical solutions disclosed in the various foregoing embodiments, or equivalent replacement may be made to part of technical features thereof, but these modifications or alterations do not make the nature of corresponding technical solutions depart from the scope of the technical solutions of the various embodiments of the disclosure.

What is claimed is:

1. A display control method, performed by an electronic device comprising a display module, the display control method comprising:
obtaining a video stream, the video stream comprising a plurality of frames of input images in sequence of time, the plurality of frames of input images having frame numbers in time order;
obtaining an index sequence having a plurality of indexes;
determining, for each of the plurality of frames of input images, an index in the index sequence corresponding to the frame of input image according to a frame number of the frame of input image;
for each of the plurality of frames of input images, generating a corresponding frame of output image by determining a pixel value of each corresponding pixel in the corresponding frame of output image according to each pixel in the frame of input image and the index corresponding to the frame of input image, to obtain a plurality of frames of output images; and
controlling the display module of the electronic device to output the plurality of frames of output images in sequence to display the video stream.

2. The display control method of claim 1, wherein determining, for each of the plurality of frames of input images, the index in the index sequence corresponding to the frame of input image according to the frame number of the frame of input image comprises:
for each of the plurality of frames of input images,
obtaining an index number of the index sequence corresponding to the frame of input image by performing a modulo operation on the frame number of the frame of input image with respect to a number of indexes in the index sequence; and
determining the index in the index sequence corresponding to the frame of input image according to the index number of the index sequence.

3. The display control method of claim 1, wherein for each of the plurality of frames of input images, generating the corresponding frame of output image by determining the pixel value of each corresponding pixel in the corresponding frame of output image according to each pixel in the frame of input image and the index corresponding to the frame of input image comprises:
for each of the plurality of frames of input images,
calculating a threshold corresponding to the frame of input image at least according to the index corresponding to the frame of input image; and
generating the corresponding frame of output image by obtaining a comparison result by comparing a pixel value of each pixel in the frame of input image with the threshold corresponding to the frame of input image, and determining the pixel value of each corresponding pixel in the corresponding frame of output image according to the comparison result.

4. The display control method of claim 3, wherein for each of the plurality of frames of input images, calculating the threshold corresponding to the frame of input image at least according to the index corresponding to the frame of input image comprises:
for each of the plurality of frames of input images, obtaining the threshold corresponding to the frame of input image according to the index corresponding to the frame of input image and a number of indexes in the index sequence.

5. The display control method of claim 4, wherein obtaining, for each of the plurality of frames of input images, the threshold corresponding to the frame of input image according to the index corresponding to the frame of input image and the number of the indexes in the index sequence comprises:
for each of the plurality of frames of input images, obtaining the threshold corresponding to the frame of input image according to a first calculation formula, the index corresponding to the frame of input image, and the number of the indexes in the index sequence, wherein
the first calculation formula is:
$$T ( i ) = 255 \times \frac{I ( i mod N ) + 0.5}{N} ,$$
wherein i represents the frame number of the frame of input image, N represents the number of the indexes in the index sequence, I(imodN) represents an index corresponding to an i^{th} frame of input image, imodN represents a result of i modulo N, and T(i) represents a threshold corresponding to the i^{th} frame of input image.

6. The display control method of claim 3, wherein for each of the plurality of frames of input images, generating the corresponding frame of output image by obtaining the comparison result by comparing the pixel value of each pixel in the frame of input image with the threshold corresponding to the frame of input image and determining the pixel value of each corresponding pixel in the corresponding frame of output image according to the comparison result comprises:
for each of the plurality of frames of input images,
determining a pixel value of a corresponding pixel in the corresponding frame of output image of the frame of input image to be a first value, in response to the comparison result being that a pixel value of a pixel in the frame of input image is greater than the threshold corresponding to the frame of input image; and
determining the pixel value of the corresponding pixel in the corresponding frame of output image of the frame of input image to be a second value, in response to the comparison result being that the pixel value of the pixel in the frame of input image is less than or equal to the threshold corresponding to the frame of input image, wherein
the first value is different from the second value.

7. The display control method of claim 1, wherein the index sequence is a random sequence or an ordered sequence.

8. The display control method of claim 1, wherein a minimum value among indexes in the index sequence is greater than or equal to 0, and a maximum value among the indexes in the index sequence is less than or equal to N-1, wherein N is a number of the indexes in the index sequence.

9. An electronic device, comprising:
a display module;
a memory, storing computer programs; and
a processor, coupled with the display module and the memory;
the processor being configured to run the computer programs to:
obtain a video stream, the video stream comprising a plurality of frames of input images in sequence of time, the plurality of frames of input images having frame numbers in time order;
obtain an index sequence having a plurality of indexes;
determine, for each of the plurality of frames of input images, an index in the index sequence corresponding to the frame of input image according to a frame number of the frame of input image;
for each of the plurality of frames of input images, generate a corresponding frame of output image by determining a pixel value of each corresponding pixel in the corresponding frame of output image according to each pixel in the frame of input image and the index corresponding to the frame of input image, to obtain a plurality of frames of output images; and
control the display module of the electronic device to output the plurality of frames of output images in sequence to display the video stream.

10. The electronic device of claim 9, wherein the processor configured to determine, for each of the plurality of frames of input images, the index in the index sequence corresponding to the frame of input image according to the frame number of the frame of input image is configured to:
for each of the plurality of frames of input images,
obtain an index number of the index sequence corresponding to the frame of input image by performing a modulo operation on the frame number of the frame of input image with respect to a number of indexes in the index sequence; and
determine the index in the index sequence corresponding to the frame of input image according to the index number of the index sequence.

11. The electronic device of claim 9, wherein the processor configured to generate, for each of the plurality of frames of input images, the corresponding frame of output image by determining the pixel value of each corresponding pixel in the corresponding frame of output image according to each pixel in the frame of input image and the index corresponding to the frame of input image is configured to:
for each of the plurality of frames of input images,
calculate a threshold corresponding to the frame of input image at least according to the index corresponding to the frame of input image; and
generate the corresponding frame of output image by obtaining a comparison result by comparing a pixel value of each pixel in the frame of input image with the threshold corresponding to the frame of input image, and determining the pixel value of each corresponding pixel in the corresponding frame of output image according to the comparison result.

12. The electronic device of claim 11, wherein the processor configured to calculate, for each of the plurality of frames of input images, the threshold corresponding to the frame of input image at least according to the index corresponding to the frame of input image is configured to:
for each of the plurality of frames of input images, obtain the threshold corresponding to the frame of input image according to the index corresponding to the frame of input image and a number of indexes in the index sequence.

13. The electronic device of claim 12, wherein the processor configured to obtain, for each of the plurality of frames of input images, the threshold corresponding to the frame of input image according to the index corresponding to the frame of input image and the number of the indexes in the index sequence is configured to:
for each of the plurality of frames of input images, obtain the threshold corresponding to the frame of input image according to a first calculation formula, the index corresponding to the frame of input image, and the number of the indexes in the index sequence, wherein
the first calculation formula is:
$$T ( i ) = 255 \times \frac{I ( i mod N ) + 0.5}{N} ,$$
wherein i represents the frame number of the frame of input image, N represents the number of the indexes in the index sequence, I(imodN) represents an index corresponding to an i^{th} frame of input image, imodN represents a result of i modulo N, and T(i) represents a threshold corresponding to the i^{th} frame of input image.

14. The electronic device of claim 11, wherein the processor configured to generate, for each of the plurality of frames of input images, the corresponding frame of output image by obtaining the comparison result by comparing the pixel value of each pixel in the frame of input image with the threshold corresponding to the frame of input image and determining the pixel value of each corresponding pixel in the corresponding frame of output image according to the comparison result is configured to:
for each of the plurality of frames of input images,
determine a pixel value of a corresponding pixel in the corresponding frame of output image of the frame of input image to be a first value, in response to the comparison result being that a pixel value of a pixel in the frame of input image is greater than the threshold corresponding to the frame of input image; and
determine the pixel value of the corresponding pixel in the corresponding frame of output image of the frame of input image to be a second value, in response to the comparison result being that the pixel value of the pixel in the frame of input image is less than or equal to the threshold corresponding to the frame of input image, wherein
the first value is different from the second value.

15. The electronic device of claim 9, wherein the index sequence is a random sequence or an ordered sequence.

16. The electronic device of claim 9, wherein a minimum value among indexes in the index sequence is greater than or equal to 0, and a maximum value among the indexes in the index sequence is less than or equal to N-1, wherein N is a number of the indexes in the index sequence.

17. A non-transitory computer-readable storage medium storing computer programs which, when executed by a processor of an electronic device, cause the processor to carry out actions, comprising:
obtaining a video stream, the video stream comprising a plurality of frames of input images in sequence of time, the plurality of frames of input images having frame numbers in time order;
obtaining an index sequence having a plurality of indexes;
determining, for each of the plurality of frames of input images, an index in the index sequence corresponding to the frame of input image according to a frame number of the frame of input image;
for each of the plurality of frames of input images, generating a corresponding frame of output image by determining a pixel value of each corresponding pixel in the corresponding frame of output image according to each pixel in the frame of input image and the index corresponding to the frame of input image, to obtain a plurality of frames of output images; and
controlling a display module of the electronic device to output the plurality of frames of output images in sequence to display the video stream.

18. The non-transitory computer-readable storage medium of claim 17, wherein the computer programs executed by the processor to carry out actions of determining, for each of the plurality of frames of input images, the index in the index sequence corresponding to the frame of input image according to the frame number of the frame of input image are executed by the processor to carry out actions, comprising:
for each of the plurality of frames of input images,
obtaining an index number of the index sequence corresponding to the frame of input image by performing a modulo operation on the frame number of the frame of input image with respect to a number of indexes in the index sequence; and
determining the index in the index sequence corresponding to the frame of input image according to the index number of the index sequence.

19. The non-transitory computer-readable storage medium of claim 17, wherein the computer programs executed by the processor to carry out actions of generating, for each of the plurality of frames of input images, the corresponding frame of output image by determining the pixel value of each corresponding pixel in the corresponding frame of output image according to each pixel in the frame of input image and the index corresponding to the frame of input image are executed by the processor to carry out actions, comprising:
for each of the plurality of frames of input images,
calculating a threshold corresponding to the frame of input image at least according to the index corresponding to the frame of input image; and
generating the corresponding frame of output image by obtaining a comparison result by comparing a pixel value of each pixel in the frame of input image with the threshold corresponding to the frame of input image, and determining the pixel value of each corresponding pixel in the corresponding frame of output image according to the comparison result.

20. The non-transitory computer-readable storage medium of claim 19, wherein the computer programs executed by the processor to carry out actions of calculating, for each of the plurality of frames of input images, the threshold corresponding to the frame of input image at least according to the index corresponding to the frame of input image are executed by the processor to carry out actions, comprising:
for each of the plurality of frames of input images, obtaining the threshold corresponding to the frame of input image according to the index corresponding to the frame of input image and a number of indexes in the index sequence.
